(19) United States
(12) Patent Application Publication
(10) Pub. No.: US 2014/0363555 A1
(43) Pub. Date: Dec. 11, 2014

(54) CUPCAKE INSERT THAT RETAINS CUPCAKES IN A DESIRED POSITION

(71) Applicants: Kip Robert Simpson, Clinton, IA (US); Robert Loren Simpson, Clinton, IA (US); Connie Susannah Davis, Clinton, IA (US)

(72) Inventors: Kip Robert Simpson, Clinton, IA (US); Robert Loren Simpson, Clinton, IA (US); Connie Susannah Davis, Clinton, IA (US)

(21) Appl. No.: 13/913,501

(22) Filed: Jun. 9, 2013

(51) Int. Cl. B65D 1/36; A21D 13/08

(52) U.S. Cl. CPC B65D 1/36; A21D 13/08
USPC 426/420; 206/563

(57) ABSTRACT

A cupcake tray has spikes, such as paperboard spikes, that extend into a cupcake cavity. The spikes prevent the cupcake from popping up and out of the insert when the cupcake box is jarred. The spikes easily fold down when the cupcake is inserted, but provide resistance in the upward direction when the cupcake box is jarred. The cupcake tray has creased panels disposed about its outer periphery to fold downward to support the cupcake tray in a cupcake box at a desired height. Each cupcake cavity in the cupcake tray has cutouts, typically semi-circular cutouts, for a user to insert their fingers to remove the cupcakes without damaging them.

### BACKGROUND OF THE INVENTION

The present invention relates to packaging supplies and, more particularly, to a cupcake insert that retains cupcakes in a desired position and prevents them from popping out.

It is important that a cupcake go into its cupcake tray easily and can be removed easily without damaging the cupcake. Standard cupcake inserts prevent cupcakes from side-to-side movement (in a plane parallel to the bottom of a cupcake box) in the cupcake box, but when the box is jarred, the cupcakes can move up and out of the cupcake insert cavity.

As can be seen, there is a need for an improved cupcake insert that retains cupcakes in a cupcake box from not only side-to-side movement, but also up-and-down movement.

### SUMMARY OF THE INVENTION

In one aspect of the present invention, a cupcake tray comprises a tray platform; tray flaps disposed about an outer periphery of the tray platform, the tray flaps adapted to fold downward to support the tray platform at a height above a surface; a plurality of cupcake slots formed in the tray platform, the plurality of cupcake slots adapted to receive a plurality of cupcakes therein; and at least one retention finger extending into the cupcake slot, the at least one retention finger being resiliently deformed when the cupcake is inserted into the cupcake slot, wherein the at least one retention finger urges the cupcake to remain in the cupcake slot, thereby preventing inadvertent cupcake displacement.

In another aspect of the present invention, a cupcake tray comprises a tray platform; tray flaps disposed about an outer periphery of the tray platform, the tray flaps adapted to fold downward to support the tray platform at a height above a surface; a plurality of cupcake slots formed in the tray platform, the plurality of cupcake slots adapted to receive a plurality of cupcakes therein; finger slots formed in an outer periphery of the cupcake slots; and at least two retention fingers extending into the cupcake slot, the at least two retention fingers being resiliently deformed when the cupcake is inserted into the cupcake slot, wherein the at least two retention fingers urges the cupcake to remain in the cupcake slot, thereby preventing inadvertent cupcake displacement.

In a further aspect of the present invention, a method of preventing movement of a cupcake in a cupcake tray comprises supporting a tray platform of the cupcake tray with a plurality of tray flaps disposed about the outer periphery thereof; placing the cupcake in a cupcake slot formed in the tray platform; and resiliently deforming one or more retention fingers extending into the cupcake slot when the cupcake is placed therein, wherein the one or more retention fingers urge the cupcake to remain in the cupcake slot, thereby preventing inadvertent cupcake displacement.

These and other features, aspects and advantages of the present invention will become better understood with reference to the following drawings, description and claims.

### BRIEF DESCRIPTION OF THE DRAWINGS

FIG. 1 is a perspective view of a cupcake tray, in use to secure cupcakes, according to an exemplary embodiment of the present invention;

FIG. 2 is a perspective view of the cupcake tray of FIG. 1, illustrating the cupcake removed therefrom;

FIG. 3 is a perspective view of the cupcake tray of FIG. 1 in a flattened state;

FIG. 4 is a perspective detailed view of the cupcake tray of FIG. 1, illustrating a user grasping and removing a cupcake therefrom; and

FIG. 5 is a cross-sectional view taken along line 5-5 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cupcake tray that has spikes, such as paperboard spikes, that extend into a cupcake cavity. The spikes prevent the cupcake from popping up and out of the insert when the cupcake box is jarred. The spikes easily fold down when the cupcake is inserted, but provide resistance in the upward direction when the cupcake box is jarred. The cupcake tray has creased panels disposed about its outer periphery to fold downward to support the cupcake tray in a cupcake box at a desired height. Each cupcake cavity in the cupcake tray has cutouts, typically semi-circular cutouts, for a user to insert their fingers to remove the cupcakes without damaging them.

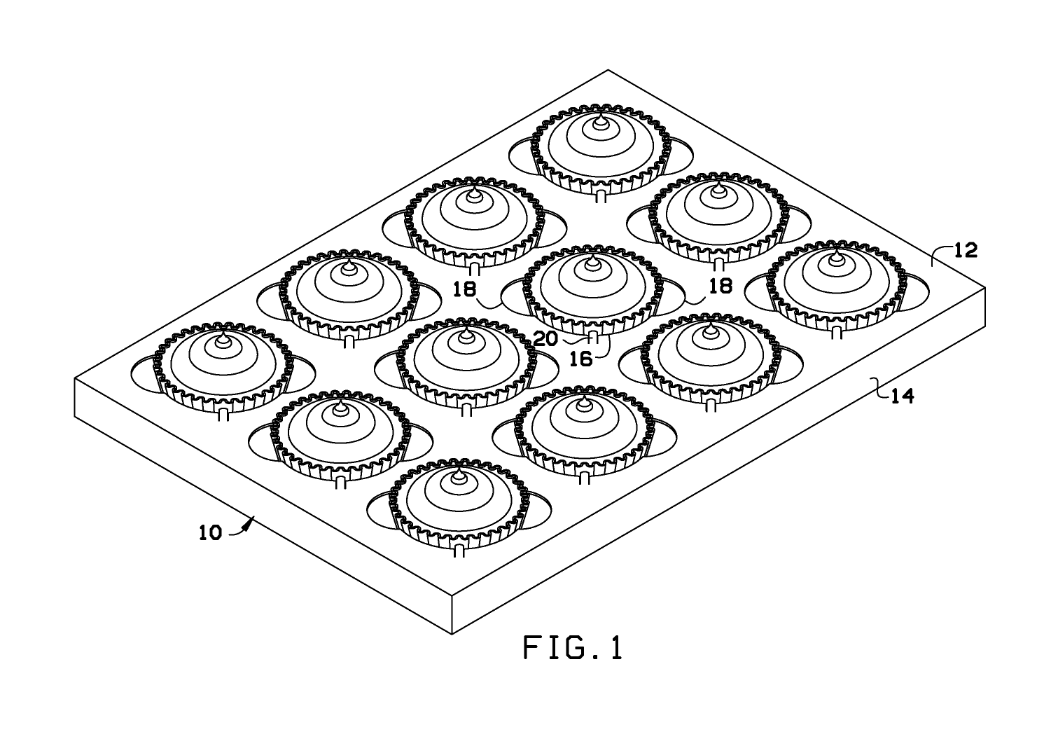

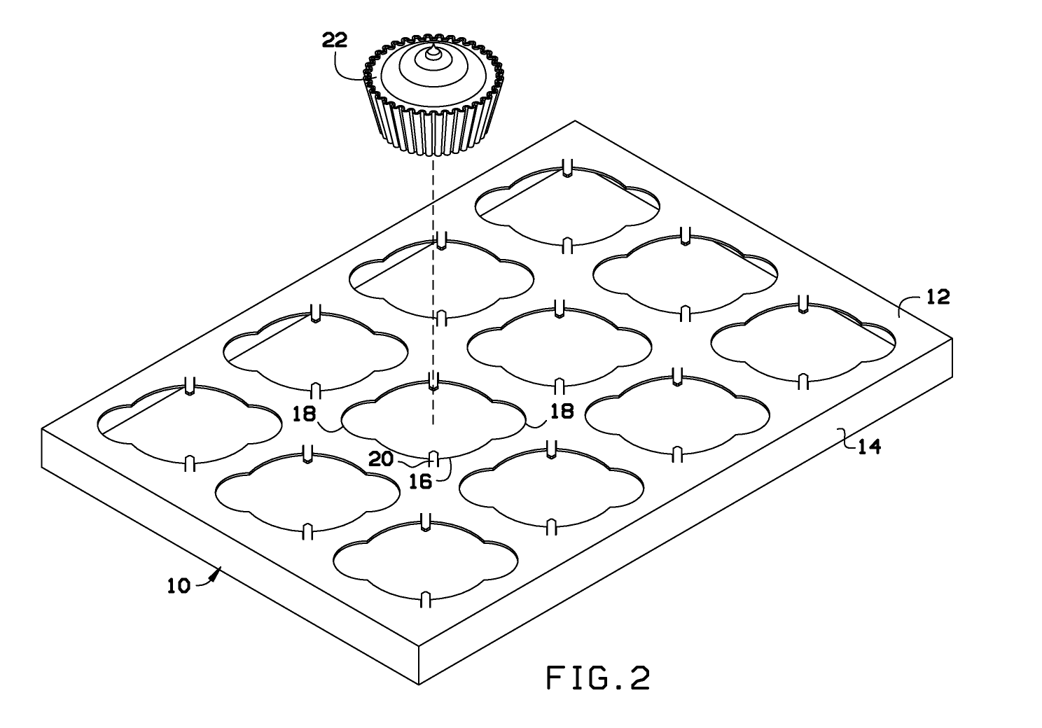

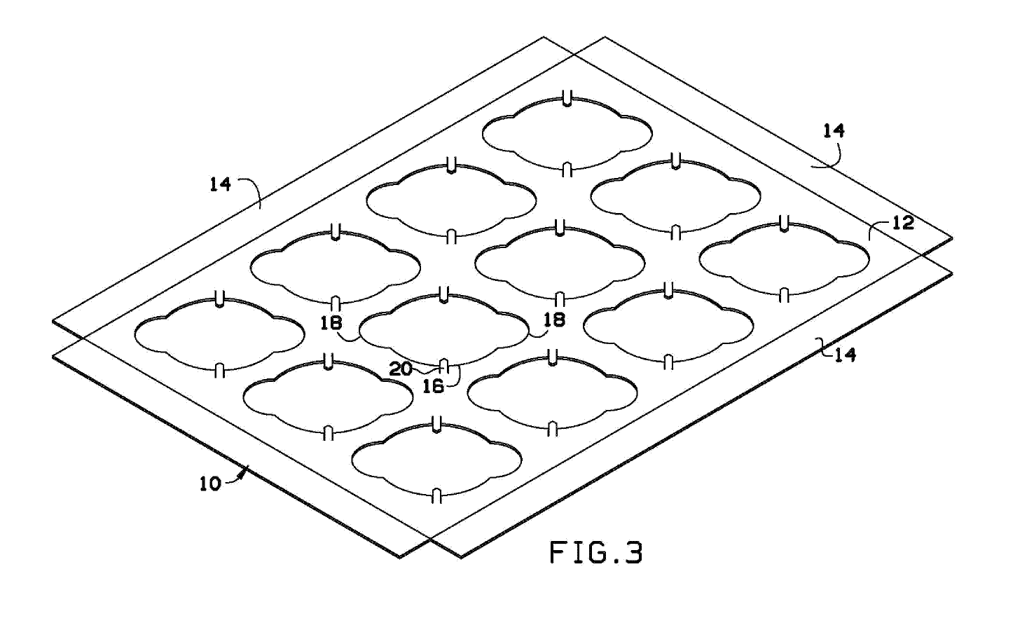

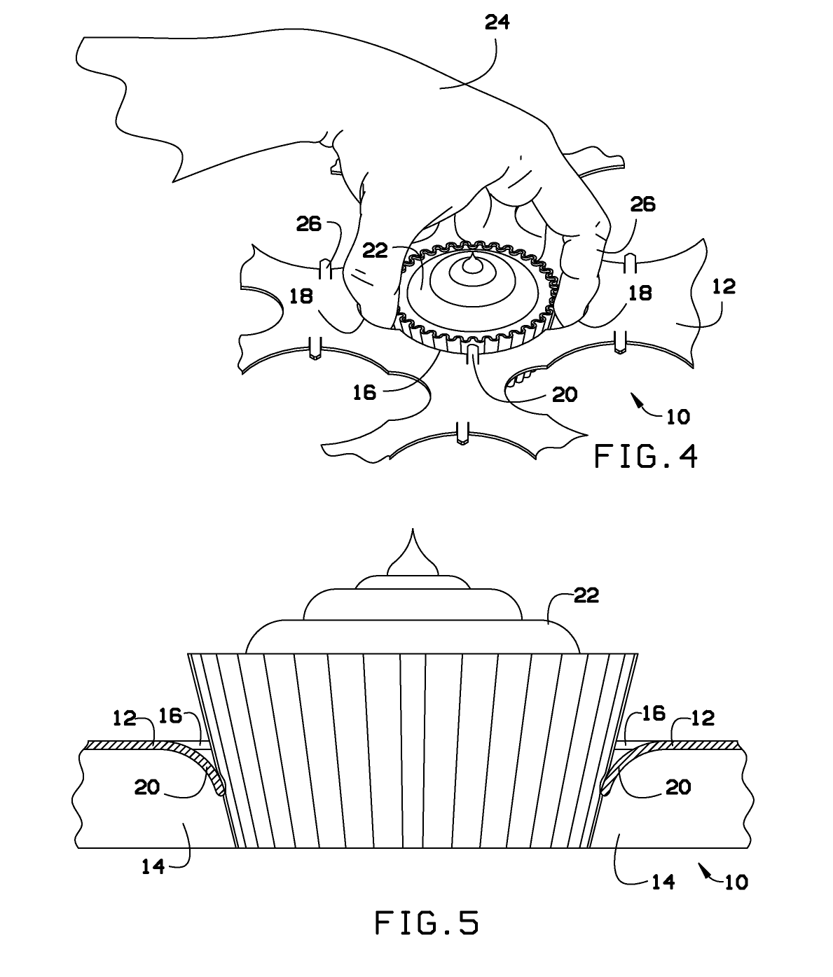

Referring now to FIGS. 1 through 5, a cupcake tray 10 includes a tray platform 12 and tray flaps 14 disposed about the outer periphery of the tray platform 12. The tray flaps 14 are designed to be folded at about a 90 degree angle relative to the tray platform 12 in order to support the tray platform 12 at a desired height (the desired height being the width of the tray flaps 14). The tray platform 12 can be sized to fit into a cupcake box (not shown) or some other container.

The tray platform 12 can include a plurality of cupcake slots 16 formed therein. Typically, twelve cupcake slots 16 can be disposed in the tray platform 12, as shown in the Figures, although other configurations and number of cupcake slots 16 are contemplated within the scope of the present invention. For example, six cupcake slots 16, arranged in a rectangle, can be disposed in the tray platform 12, or any number of cupcake slots 16 can be disposed in a configuration, such as in a circle, on the tray platform 12.

The cupcake slots 16 are typically round slots, sized to generally match the diameter of the cupcake 22 resting in the cupcake slot 16. Finger slots 18 can be disposed as cut-outs along the outer periphery of the cupcake slot 16. Typically, the finger slots 18 are semi-circular cut-outs, allowing a user 24 to insert their fingers 26 into the finger slots 18 to remove the cupcake 22. Typically, the finger slots 18 are two finger slots 18 disposed on opposite sides of the cupcake slot 16.

At least one and typically two or more retention fingers 20 can extend from the outer periphery of the cupcake slot 16 into the cupcake slot 16, typically toward the center thereof. The retention fingers 20 can be formed partly from the tray platform 12 by cutting generally parallel cuts into the tray platform, and the retention fingers 20 can extend into the cupcake slot 16 a sufficient distance such that when the cupcake 22 is inserted into the cupcake slot 16, the retention fingers 20 resiliently bend downward, as shown in FIG. 5. The retention fingers 20 contact the outer surface of the cupcake 22 (the cupcake wrapper) to prevent the cupcake from unintentionally popping out of the cupcake slot 16. In some embodiments of the present invention, the retention fingers 20 can terminate with a point by cutting the ends thereof at an angle. Other shapes for the retention fingers 20, however, are contemplated within the scope of the present invention.

While two retention fingers 20 are shown in the Figures, three, four, or more such retention fingers 20 can be used for each cupcake slot 16. Typically, the retention fingers 20 are equally spaced about the outer periphery of the cupcake slot 16.

While the Figures show a cupcake tray 10 that is designed to fit into a cupcake box, for example, the cupcake tray 10 could be integrated into the design of the cupcake box.

In some embodiments, the tray flaps 14 can be made of various widths such that more than one cupcake tray 10 could be used, with one tray platform 12 disposed above another, with the upper tray platform having a larger cupcake slot 16 in order to conform with the cone-shape bottom of the cupcake. In some embodiments, an adhesive could be used on the retention fingers 20 to help secure the cupcakes 22 in place.

It should be understood, of course, that the foregoing relates to exemplary embodiments of the invention and that modifications may be made without departing from the spirit and scope of the invention as set forth in the following claims.

What is claimed is:

1. A cupcake tray comprising:
a tray platform;
tray flaps disposed about an outer periphery of the tray platform, the tray flaps adapted to fold downward to support the tray platform at a height above a surface;
a plurality of cupcake slots formed in the tray platform, the plurality of cupcake slots adapted to receive a plurality of cupcakes therein; and
at least one retention finger extending into the cupcake slot, the at least one retention finger being resiliently deformed when the cupcake is inserted into the cupcake slot, wherein
the at least one retention finger urges the cupcake to remain in the cupcake slot, thereby preventing inadvertent cupcake displacement.

2. The cupcake tray of claim 1, wherein the at least one retention finger is at least two retention fingers.

3. The cupcake tray of claim 1, wherein the at least one retention finger is two retention fingers disposed on opposite sides of the cupcake slot.

4. The cupcake tray of claim 1, further comprising finger slots formed in an outer periphery of the cupcake slots.

5. The cupcake tray of claim 1, wherein the retention fingers are formed partially from the tray platform by forming generally parallel cuts into the tray platform.

6. A cupcake tray comprising:
a tray platform;
tray flaps disposed about an outer periphery of the tray platform, the tray flaps adapted to fold downward to support the tray platform at a height above a surface;
a plurality of cupcake slots formed in the tray platform, the plurality of cupcake slots adapted to receive a plurality of cupcakes therein;
finger slots formed in an outer periphery of the cupcake slots; and
at least two retention fingers extending into the cupcake slot, the at least two retention fingers being resiliently deformed when the cupcake is inserted into the cupcake slot, wherein
the at least two retention fingers urges the cupcake to remain in the cupcake slot, thereby preventing inadvertent cupcake displacement.

7. The cupcake tray of claim 6, wherein the retention fingers are formed partially from the tray platform by forming generally parallel cuts into the tray platform.

8. A method of preventing movement of a cupcake in a cupcake tray, comprising:
supporting a tray platform of the cupcake tray with a plurality of tray flaps disposed about the outer periphery thereof;
placing the cupcake in a cupcake slot formed in the tray platform; and
resiliently deforming one or more retention fingers extending into the cupcake slot when the cupcake is placed therein, wherein
the one or more retention fingers urge the cupcake to remain in the cupcake slot, thereby preventing inadvertent cupcake displacement.

9. The method of claim 8, wherein the one or more retention fingers are two retention fingers disposed on opposite sides of the cupcake slot.

10. The method of claim 8, further comprising removing the cupcake from the cupcake slot by inserting fingers into finger slots formed in an outer periphery of the cupcake slots to grasp and lift the cupcake.
